(19) United States
(12) Patent Application Publication
(10) Pub. No.: US 2022/0051648 A1
(43) Pub. Date: Feb. 17, 2022

(54) MIDI CONTROLLER AND SYSTEM FOR DISTRIBUTING MEDIA THEREWITH

(71) Applicant: Chad Gerber, Los Angeles, CA (US)

(72) Inventor: Chad Gerber, Los Angeles, CA (US)

(21) Appl. No.: 17/399,331

(22) Filed: Aug. 11, 2021

Related U.S. Application Data
(60) Provisional application No. 63/064,783, filed on Aug. 12, 2020.

(51) Int. Cl. G10H 1/00; G10H 3/18; G02B 27/01; G06T 19/00

(52) U.S. Cl. CPC G10H 1/0075; G10H 3/188; G10H 2240/031; G06T 19/006; G10H 2240/005; G02B 27/017

(57) ABSTRACT

A musical instrument digital interface (MIDI) controller is provided. It has a housing having a hollow interior portion, a first audio jack and a second audio jack positioned on the housing, wherein the first audio jack is configured to accept a first audio signal from an electronic music instrument, and wherein the second audio jack is configured to accept a second audio signal from a microphone, a conversion module configured to receive the first signal from the first audio jack and the second signal from the second audio jack, wherein the conversion module is configured to transform the first signal into an outgoing digital signal and retain the second signal in a database and an output module configured to utilize the outgoing digital signal and the retained second signal from the database, and output both signals as a dual signal of audio and digital outputs during a user performance.

### CROSS-REFERENCE TO RELATED APPLICATION

This application claims the benefit of U.S. Provisional Patent Application Ser. No. 63/064,783 filed Aug. 12, 2020 entitled Midi Controller and System of Distributing Media Therewith, the entire contents of which are incorporated by reference herein for all purposes.

### FIELD OF THE INVENTION

The present invention generally relates to a device for capturing media (e.g., music) and a system for distributing live music, digital recordings, via a virtual or augmented reality platform. More specifically, the present invention relates to a modified MIDI controller for enabling a user or a musician to capture music or perform live music and simultaneously provide a virtual reality (VR) music experience for a viewer via a VR/AR platform using, a VR/AR headset and also enable the users and/or musician to interact with each other.

### BACKGROUND

The music industry involves a vast amount of people to create, produce, perform, record, promote, and manage to create profitable business. Whilst the digital music era has created an environment in which it is easy to purchase, download, stream, and listen to music, a vast amount of revenue for musicians and artists is derived from live performances.

The COVID-19 pandemic, also known as the coronavirus pandemic, is a pandemic of coronavirus disease 2019 (COVID, Äë19), caused by severe acute respiratory syndrome coronavirus 2 (SARS, ÄëCoV, Äë2). The World Health Organization declared the outbreak a Public Health Emergency of International Concern on 30 Jan. 2020.

In response, many governments across the world have either declared or recommended that people “social distance” to obviate the spread of the disease. In public health, social distancing, also called physical distancing, is a set of non-pharmaceutical interventions or measures intended to prevent the spread of a contagious disease by maintaining a physical distance between people and reducing the number of times people come into close contact with each other. It typically involves keeping a certain distance from others (the distance specified may differ from time to time and country to country) and avoiding gathering together in large groups. In the United States, the recommend distance is six feet. By reducing the probability that a given uninfected person will come into physical contact with an infected person, the disease transmission can be suppressed, resulting in fewer deaths. This has virtually destroyed artists' ability to play live venues and earn a revenue stream. Further, fans and concert goers yearn for the concert and live experience, and they are missing this opportunity because of Covid-19 and other potential oncoming pandemics.

Virtual Reality (VR) and augmented reality (AR) has made great advances recently. VR entertainment systems utilizing VR headsets, head mounted displays, and other immersive devices or methods, whereby a participant views and interacts with a software-generated virtual reality environment have been used for training and entertainment purposes. However, the sound isn't comparable to what a fan experiences at a live concert especially if the music is derived from a classic MIDI controller.

A MIDI is any hardware or software that generates and transmits Musical Instrument Digital Interface data to MIDI-enabled devices, typically to trigger sounds and control parameters of an electronic music performance.

However, current systems and models only allow for converting the audio signal into a MIDI signal within digital audio workstations on an interface, and the resulting sound suffers in the it does not have a live feel.

In light of the above-mentioned problems, there is a need for a device to capture high-quality live sound and a system provide a VR or AR music experience for a viewer or listener via a networked platform.

### SUMMARY OF THE INVENTION

The present invention generally discloses a device capturing media (e.g., music) and a networked system for distributing music via a virtual reality platform. Further, the present invention discloses an interface device for enabling a user or a musician to perform live music and configured to simultaneously provide a virtual reality (VR) or augmented realty (AR) music experience for a viewer via a VR platform using, but not limited to, a VR headset and also enable the user or musician to record the music and distribute using a VR based recording software so other users can access and stream via the VR platform using the VR headset.

In one embodiment a device for capturing music is provided. The device comprises a central processing unit (CPU) or a processor, a memory, a Bluetooth module, a data module, at least two mono female audio jack inputs, a data storage unit, a user data/profile, and a power input. In one embodiment, the memory, Bluetooth module, data module, data storage unit, and the power input are in commutation with the CPU. In one embodiment, the interface device further comprises at least one universal serial bus (USB-C) port for connecting to external devices, for example, a VR headset via a cable.

In one embodiment, the interface device is configured to receive at least two audio signals from electronic music instruments such as, but not limited to, guitars or bass guitars, keyboards, and microphones and the like, and further convert those audio signals into an outgoing digital signal as musical instrument digital interface (MIDI) while simultaneously retaining an outgoing audio signal. In one embodiment, the electronic music instruments such as, but not limited to, guitars or bass guitars, keyboards, and microphones are wirelessly connected to the interface device via a network, for example, Bluetooth®. A wired connection may be usable as well.

In operation, the hardware (the MIDI) receives audio signals from electronic instruments such as, but not limited to, guitars or bass guitars, keyboards, and microphones and converts those audio signals into an outgoing digital signal (commonly referred to as MIDI) while simultaneously retaining an outgoing audio signal. This allows for dual output signals of audio and digital (MIDI). This allows the user to create better sounding and more “live sounding” music. The user can play live, and others can watch and listen using a VR headset and the online web platform for distribution of more quality sounding music.

In one embodiment, the interface device is configured to receive at least to two audio signals from electronic music instruments such as, but not limited to, guitars, bass guitars, keyboards, and microphones and further convert those audio signals into an outgoing digital signal as musical instrument digital interface (MIDI) while simultaneously retaining an outgoing audio signal. This allows for dual output signals of both audio and digital (MIDI) to be used for recording and live streaming via, but not limited to, Bluetooth® connectivity or USB-C connectivity within the virtual reality platform. In one embodiment, additionally, the interface device is further configured to be used as an audio interface with personal computers (PCs) using digital audio work stations such as, but not limited to, Pro Tools®, Ableton®, Logic Pro®, FL Studio® and the like with basic recording programs on at least one or more electronic devices, for example, iPhones®, iPads®, and other Android® based devices.

In one embodiment, the interface device further comprises a standard power input, a universal serial bus (USB-C) port, and a Bluetooth sync button or port. In one embodiment, the standard power input is configured to receive electrical power from a power supply and supply electrical power to the interface device. In one embodiment, the mono female audio jack inputs are where the audio signals enter into the interface device. In one embodiment, the circuit board, processor, and the hard drive will convert the audio signal to digital and work with, but not limited to, the VR headsets, head mounted displays, and other immersive devices in facilitating virtual environments, software plugins, room skins, and mapping MIDI data. In one embodiment, the USB-C port, and a Bluetooth sync button or port will conduct outgoing digital/MIDI signals and communicate between the interface and VR/AR headsets to facilitate the online and music studio virtual experience of recording, producing, and performing music with a digital audio workstation and unlockable creator features within the VR platform.

In one embodiment, a musical instrument digital interface (MIDI) controller is provided and comprises a housing having a hollow interior portion, a first audio jack and a second audio jack positioned on the housing, wherein the first audio jack is configured to accept a first audio signal from an electronic music instrument, and wherein the second audio jack is configured to accept a second audio signal from a microphone, a conversion module configured to receive the first signal from the first audio jack and the second signal from the second audio jack, wherein the conversion module is configured to transform the first signal into an outgoing digital signal and retain the second signal in a database, an output module configured to utilize the outgoing digital signal and the retained second signal from the database, and output both signals as a dual signal of audio and digital outputs during a user performance.

In an embodiment, a system for mixing media is provided. The system comprises a musical instrument digital interface (MIDI) controller comprising, a housing having a hollow interior portion, a first audio jack and a second audio jack positioned on the housing, wherein the first audio jack is configured to accept a first audio signal from an electronic music instrument, and wherein the second audio jack is configured to accept a second audio signal from a microphone, a conversion module configured to receive the first signal from the first audio jack and the second signal from the second audio jack, wherein the conversion module is configured to transform the first signal into an outgoing digital signal and retain the second signal in a database, an output module configured to utilize the outgoing digital signal and the retained second signal from the database, and output both signals as a dual signal of audio and digital outputs; a digital audio workstation module configured to communicate with the MIDI and generate a media using the dual signal of audio and digital outputs, a virtual reality (VR) module in communication with the digital audio workstation, wherein the VR module is configured to receive a signal from the digital audio workstation module to allow a user to interact with the media.

In an embodiment, a method performed by a processor of mixing a MIDI signal is provided. The method comprises accepting a first audio signal from an electronic music instrument using a first audio jack on a MIDI controller, accepting a second signal from a microphone using a second audio jack on the MIDI controller, transforming the first signal into an outgoing digital signal, retaining the second signal in a database, transforming the first signal into an outgoing digital signal and retaining the second signal in a database using a conversion module, and mixing the outgoing digital signal and the saved second signal during a user performance and outputting both signals as a dual signal of audio and digital outputs.

In one embodiment, the interface device has processing capabilities and software packages that will be processed and accessed between the interface device and VR/AR headsets, head mounted displays, and other immersive devices.

In an embodiment, a system is used for performing live music, digital recording, distributing, and advertising via a virtual reality platform (VR/AR) in one embodiment is disclosed. In one embodiment, the interface device is configured to enable a user or a musician to perform live music and simultaneously provide a virtual reality (VR) music experience for a viewer via a VR platform using, but not limited to, a VR headset, head mounted displays, and other immersive devices or methods and also enable the user or musician to record the music and store within a database and also distribute using a VR based recording software so other users could access and stream via the VR platform using the VR headset.

Also, a user may record the music and run it through a digital audio workstation to perfect it, then store it in the data storage or a database so other users can view later using the system described herein. In networked platform disseminates it. In one embodiment, the system or platform enables the user to create, share, and experience the music, provides dynamic connection between artists and fans, open access to explore new music, meet other fans, support their favorite artists, and dabble in creating their own tracks, opportunities for users to buy, sell, and earn music, digital goods, and tickets for events, and also the musicians or artists could perform at live events and mingle with fans and musicians from around the world.

In one embodiment, the hard drive comprises software and the processor are configured to enable the viewers and listeners to experience the live music performances via the VR platform combined with the MIDI. In one embodiment, the musicians or music creators have a music studio space within the platform where they create music and collaborate with other musicians. They could also hang out or perform their music at the studio or venues and interact with other music creators or the fans.

In embodiments, a personal avatar accesses a personal VR studio and may also use different tools for creating music and cloud storage, live performances, opportunities to earn income, additional incentives for users, and advertising are given. In one embodiment, different avatar skins such as, but not limited to, clothes, styles, animations are available and also exclusive avatars have “performance” animations and other functions such as, but not limited to, rock n roll hand gestures, air guitar animations, and other movements.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of a system for performing live music, digital recording, distributing, and digital advertising using an interface device in an embodiment of the present invention.

FIG. 2 shows a block diagram of the interface device or unit, or a web platform connected to a VR headset and also wirelessly connected to a virtual studio, a virtual venue, merchandise, social media via a network in one embodiment of the present invention.

FIG. 3 shows a front view of the interface device or unit having at least two mono female audio jack inputs in one embodiment of the present invention.

FIG. 4 shows a front perspective view of the interface device in one embodiment of the present invention.

FIG. 5 shows a rear view of the interface device or unit having a standard power input, a universal serial bus (USB-C) port, and a Bluetooth sync button or port in one embodiment of the present invention.

FIG. 6 shows a rear perspective view of the interface device in one embodiment of the present invention.

FIG. 7 shows another block diagram of a system for performing live music, digital recording, distributing, and digital advertising using an interface device in an embodiment of the present invention.

FIG. 8 shows block diagram of a system for performing live music, digital recording, distributing, and digital advertising using an interface device in an embodiment of the present invention.

FIG. 9 shows a front perspective view of the interface device in one embodiment of the present invention.

### DETAILED DESCRIPTION OF EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described are shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be also understood to refer to functional equivalents of such structures. The present invention will now be described in detail with reference to embodiments thereof as illustrated in the accompanying drawings.

As used herein, MIDI relates to a Musical Instrument Digital Interface data to MIDI-enabled devices, typically to trigger sounds and control parameters of an electronic music performance. MIDI controllers typically have some type of interface that the performer presses, strikes, blows or touches. This action generates MIDI data (e.g., notes played and their intensity), which can then be transmitted to a MIDI-compatible sound module or synthesizer. The sound module or synthesizer in turn produces a sound that is amplified through speakers. The most commonly used MIDI controller is the electronic musical keyboard MIDI controller. When the keys are played, the MIDI controller sends MIDI data about the pitch of the note, how hard the note was played and its duration. Other common MIDI controllers are wind controllers and drums. While all these instruments are applicable herein, the MIDI described herein is used in relation to MIDIs for use with guitars.

As used herein, the term “user” shall mean any individual who utilizes the system and methods described herein.

As used herein, the term “VR” shall mean virtual reality or augmented reality.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

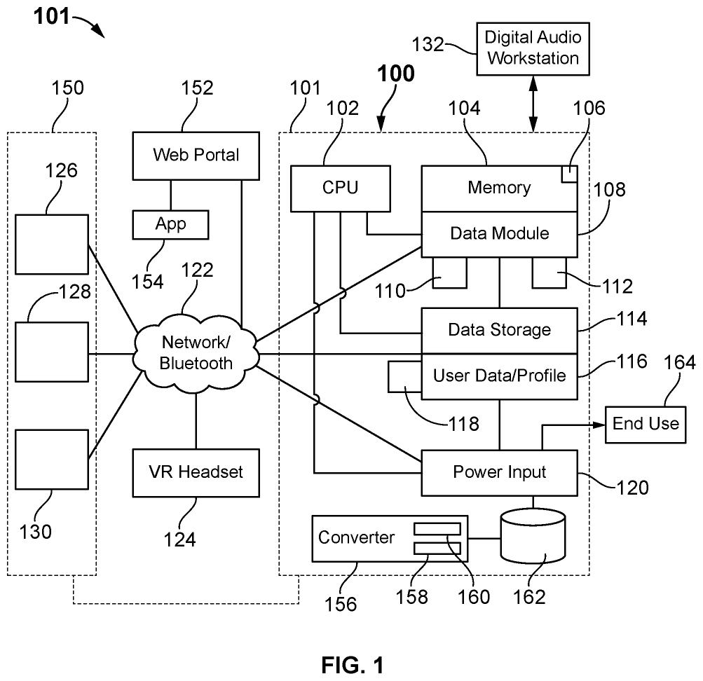

Referring now to FIG. 1, a block diagram of device and system for performing live music, digital recording, and distributing platform 101 using an interface device 100 is shown. In one embodiment, the interface device 100 (sometimes referred to as a MIDI or MIDI controller) enables a musician to create music and to perform live music and simultaneously provide a virtual reality (VR/AR) music experience for a viewer via a VR platform using, but not limited to, a VR headset 124, head mounted displays, and other immersive devices or methods and also enable the user or musician to record the music and store within a data module 108 or a database and also distribute using a VR based recording software so other users could access and stream via the VR platform using the VR headset 124. In one embodiment, the VR headset 124 is wirelessly connected to the interface device 100 via a network 122 or a wired connection.

In one embodiment, the MIDI 100 comprises a central processing unit (CPU) or a processor 102, a memory 104, a Bluetooth® module 106, a data module 108, at least two mono female audio jack inputs (110 and 112), a data storage unit 114, a user data/profile 116, and a power input 120. In one embodiment, the memory 104, Bluetooth® module 106, data module 108, data storage unit 114, and the power input 120 are in commutation with the CPU 102. In one embodiment, the interface device 100 further comprises at least one universal serial bus (USB-C) port 118 for connecting to external devices, for example, a VR headset 124 via a cable.

The MIDI 100 is configured to receive at least to two audio signals from electronic music instruments 150 such as, but not limited to, guitars or bass guitars 126, keyboards 128, and microphones 130 and further convert those audio signals into an outgoing digital signal as musical instrument digital interface (MIDI) while, importantly, simultaneously retaining an outgoing audio signal. This allows for vast expansion of creative possibilities with one audio signal. Retention of the original audio quality of the instrument as it is performed is maintained and utilized within music production, as well as a digital format that can be electronically manipulated within a Digital Audio Workstation into virtually unlimited instruments, sounds, textures, beats, etc. for further musical creation. It also improves efficiency of music production workflow as it reduces the number of times a musicians must play the same musical piece. As an example, for the digital signal, a musician may play a song on a guitar once, then have the original sound of that guitar playing, but also reformat it into a into a piano, violin, drums, and the like, playing the same piece, or it may be chop it up into different sounds. In another example, a vocalist record through a microphone and keep that original vocal as well as manipulate it into different sounding voices, other instruments, vocoder, and the like. In one embodiment, the musical instruments 150 are wirelessly connected to the interface device 100 via a network 122, for example, Bluetooth®.

In operation, the MIDI 100 receives signals from both the user musical instruments 150 and microphones and receives two incoming audio signals from electronic instruments such as, but not limited to, guitars or bass guitars 126, keyboards 128, and microphones 130 and, using conversion module 156, convert those audio signals into an outgoing digital signal (commonly referred to as MIDI) while simultaneously retaining an outgoing audio signal. This allows for dual output signals of audio and digital (MIDI) to create better sounding music. The conversion module 156 comprises A/D module 158 and persisted module 160 in communication with database 162. The A/D module is configured to convert the incoming audio signal into an outgoing digital signal, and the persisted module is configured to retain the outgoing audio signal and store it in database 162 for use later during mixing. An output module 164 allows for dual output signals of audio and digital (MIDI) to be used for recording and live streaming via, Bluetooth® connectivity or USB-C connectivity within the virtual reality platform to end use 166.

The user can play live, and others can watch and listen using a VR headset 124 or an online web platform 152 or mobile application 154. Also, a user may record the music (not live) and run it through a digital audio workstation 132 to perfect it, then store it in the data storage 114 or a database so other users can view later using the platform 101. The VR headset 124 has a partially transparent projection screen that covers the eyes of the user and headphones 120 to provide for accompanying audio. In optional embodiments, the headphone may also be coupled to a microphone that will allow the user to use voice commands or to communicate with other participants in the virtual reality.

A digital audio workstation 132 (DAW) is provided and in electronic communication with the interface 100. In embodiments, the DAW will be hosted by and stored on the interface device and then projected into the VR headset from the interface. In operation, the interface is the computer with the DAW software installed on it and the headset acts as the computer monitor, just with a virtual platform This allows a user to mix and use the interface with digital audio workstations such as Pro Tools®, Ableton®, Logic Pro®, FL Studio® and the like, and to use the device with recording programs on iPhone®, iPad®, and Android® based devices.

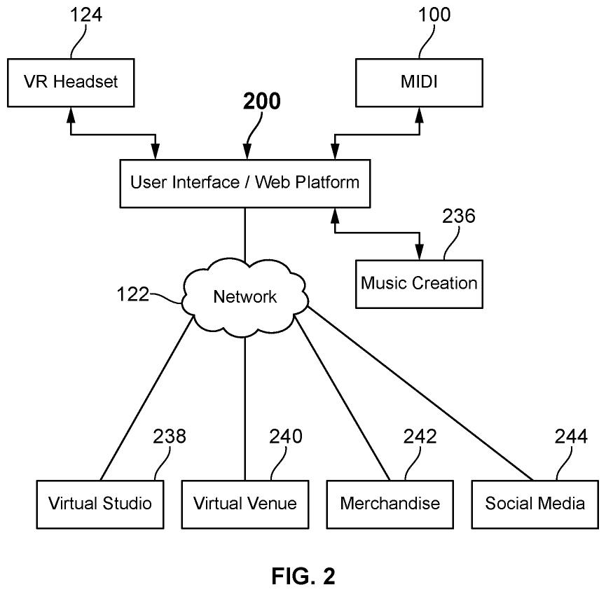

Now Referring to FIG. 2, a block diagram of the interface or a web platform 200 producing and distributing music is provided. The web platform 200 may be in communication with the VR headset 124 and also wirelessly connected to a virtual studio 238, a virtual venue 240, merchandise module 242, and social media module 244 via a network 222 is disclosed. In one embodiment, the web platform 200 is configured to provide and distribute live music via the VR headset 124, create and produce music using a MIDI 100 and a music creation module 236, provide a virtual studio 238 for live music collaboration, and performance venues or virtual venues 240.

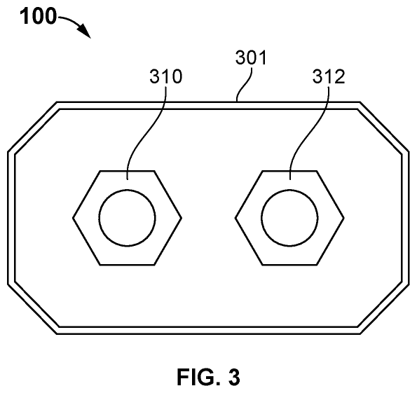

In operation, the web platform may be a web-based platform, a mobile application running on a smart device, or an application running on a VR headset 124. The platform 200 allows the plurality of users to create events, utilize social media or networking, provide content creator incentives, music distribution, and use e-commerce for merchandise 242 for advertisers. In one embodiment, the web platform enables the user to create, share, and experience the music, provides experiential and deeply engaging communities, enables collaborative opportunities between artists and dynamic connection between artists and fans, open access to explore new music, meet other fans, support their favorite artists, and create their own tracks, opportunities for users to buy, sell, and earn music, digital goods, and tickets to events, enables spaces for artists from novice to professional to create, collaborate, and showcase their music, and also artists could perform at live events and communicate with fans and musicians from around the world. The platform 200 is configured to work with the MIDI 100 to provide the uses higher quality sound based on the configuration of the MIDI coupled with the inputs and outputs to the platform. The MIDI 100 converts audio signals into an outgoing digital signal while simultaneously retaining an outgoing audio signal. This allows for dual output signals of audio and digital (MIDI) to create better sounding music described in greater detail with relation to FIGS. 3-9.

Referring to FIG. 3, MIDI 100 used for creating and distributing digital recordings and live music is shown. In one embodiment, the interface device 100 is configured to receive at least to two audio signals from electronic music instruments 150 such as, but not limited to, guitars, bass guitars, keyboards, and further, or audio inputs from a user microphone. The MIDI is configured to convert those audio signals into an outgoing digital signal using MIDI 100 while, importantly, simultaneously retaining an outgoing audio signal. This allows for dual output signals of audio and digital (MIDI) to be used for recording and live streaming via, Bluetooth® connectivity or USB-C connectivity within the virtual reality platform. In one embodiment, additionally, the interface device 100 is further configured to be used as an audio interface with personal computers (PCs) using digital audio workstations such as, but not limited to, Pro Tools®, Ableton®, Logic Pro®, FL Studio® and the like. Each may be used with basic recording programs on at least one or more electronic devices, for example, iPhones®, iPads®, and other Android® based devices. In one embodiment, the MIDI 100 comprises a housing 301 and at least two mono female audio jack inputs (310 and 312) on one end or face of the MIDI 100. In one embodiment, the interface device 100 further comprises a circuit board having a hard drive loaded with software, a transmitter for Bluetooth® connectivity, and a processor. In one embodiment, the mono female audio jack inputs (310 and 312) are configured to receive at least to two audio signals from electronic music instruments and microphones, and further convert those audio signals into an outgoing digital signal while simultaneously retaining an outgoing audio signal using the hard drive of the MIDI. In sum, additional ports such as the USB-C for the VR headset, two USB's on each on front and back for any potential file transfer from external drives, plugging in dongles, controllers or other electronic music inputs and the like may be employed.

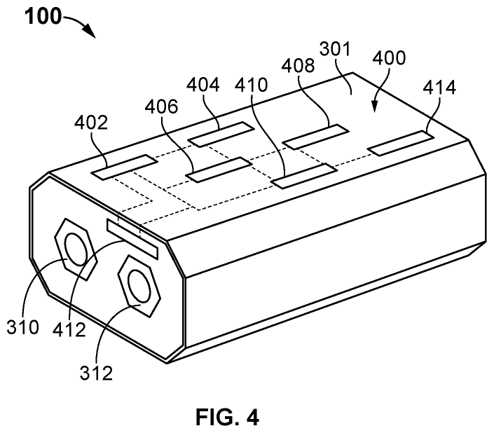

Referring now to FIG. 4 a front perspective view of the interface device in one embodiment of the present invention are shown together with internal components inside of the hollow body 400. The device components comprise, among other components, a motherboard 402, processor 404, RAM 406, hard-drive 408, and integrated video 410. It may further comprise an audio interface 412 configured to exchange data with the VR components and further configured to capture and play back music using the built-in audio interface. In operation, the motherboard 402, processor 404, RAM 406, hard-drive 408, integrated video 410 and an audio interface 412 are connected to each other via various circuitry components and communicate with each other take audio signals in, and output digital signals while using the database 414 to simultaneously retain an outgoing audio signal.

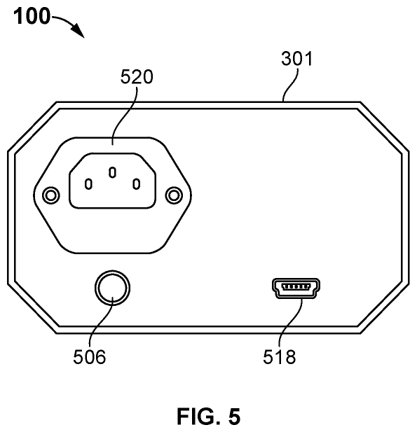

Referring now to FIG. 5 shows a rear view of the interface device or unit having a standard power input, a universal serial bus (USB-C) port, and a Bluetooth sync button or port in one embodiment of the present invention. It should be noted that these components may be on any face of the housing 301. A headphone jack 506 may be included and act as an audio output to external headphones via jack, mini-jack connectors, or it may utilize an audio transmission via a USB input or output 518. The power supply 520 may comprise an external power supply unit from the AC network with a voltage of 110/220 volts. In one embodiment, the standard power input 520 is configured to receive electrical power from a power supply and supply electrical power to the interface device 100. In one embodiment, the mono female audio jack inputs (410 and 412) (shown in FIG. 4) are where the audio signals enter into the interface device 100. In one embodiment, the circuit board, processor, and the hard drive will convert the audio signal to digital and work with, but not limited to, the VR headsets, head mounted displays, and other immersive devices in facilitating virtual environments, software plugins, room skins, and mapping MIDI data. In one embodiment, the USB-C) port 518, and a Bluetooth sync button or port 506 will conduct outgoing digital/MIDI signals and communicate between the interface and VR/AR headsets to facilitate the online and music studio virtual experience of recording, producing, and performing music with a digital audio workstation and unlockable creator features within the VR platform. Connections to an external monitor, keyboard, and mouse manipulator may be made using the USB.

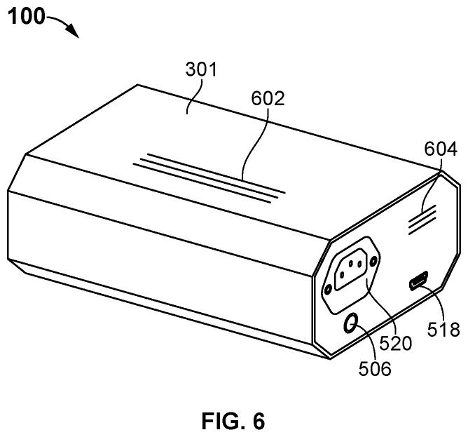

FIG. 6 shows a rear perspective view of the interface device in one embodiment of the present. In operation, the device 100 is manufactured from metal or aluminum, or has may be formed of plastics. On the lower plane of the case, there may be rubber non-slip feet for placing the device on horizontal surfaces. There are ventilation slots 602 and 604 on the top and side surfaces of the housing but may be on any side. The device 100 rear panel has ventilation slots 604, USB 518, (or USB-C, HDMI port), the connector for a power supply 520, the connector for headphone mini-jack plug 506, the RJ45 Ethernet connector, and connector for removable external Wi-Fi antenna.

In one embodiment, the interface device 100 is further configured to use as an interface with, but not limited to, iPads, iPhones, and other tablet technology for performing live (giving access to unlimited sounds and instruments) or recording music in basic recording software. In one embodiment, the interface device 100 has processing capabilities and software packages that will be processed and accessed between the interface device 100 and VR/AR headsets, head mounted displays, and other immersive devices. In one embodiment, the interface device 100 additionally acts as a key to unlock special features within the platform, hosted on the actual device.

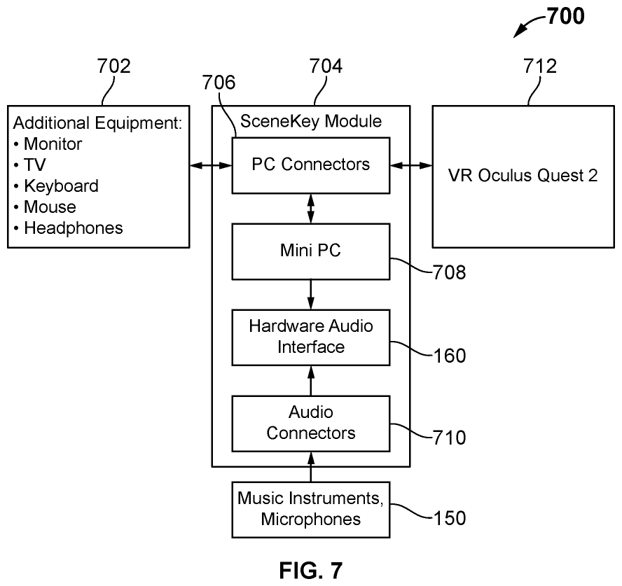

Referring now to FIG. 7, another block diagram of a system for performing live music, digital recording, distributing, and digital advertising using an interface device in an embodiment of the present invention is provide at reference numeral 700. The system, in this embodiment, comprises production equipment 702 in communication with a production module 702 comprising hardware including but not limited to, PC connectors, 706, mini-pc 708, MIDI 100 and audio connectors 710. The module is in communication with VR/AR component 712 and configured to output data to the VR/AR component for viewing after or during production of the media.

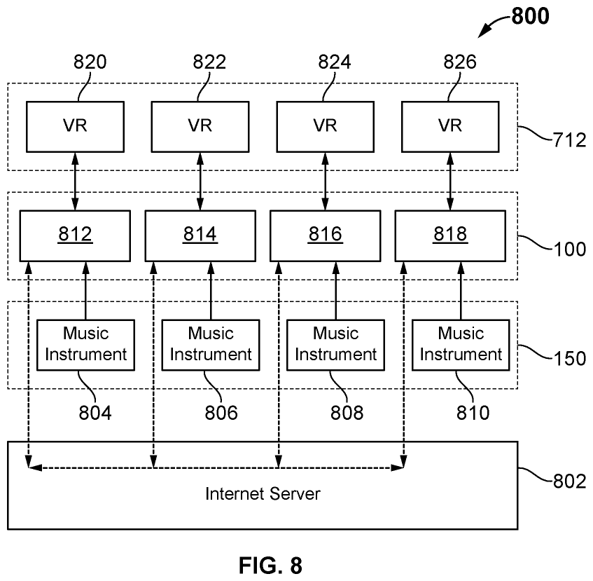

With reference now to FIG. 8 shows block diagram of a system for performing live music, digital recording, distributing, and digital advertising using an interface device in an embodiment of the present invention. In this embodiment, the system comprises internet server 802 in communication with musical instrument layer 150 which comprises a plurality of instruments, namely, instrument 802, instrument 804, instrument 806, instrument 808, and instrument 810. The instruments are in a communication with a plurality of MIDIs 100 layer, namely, MIDI 812, MIDI 814, MIDI 816, and MIDI 818. The MIDIs are 100 are in communication a plurality of VR devices 712 namely, VR 820, VR 822, VR 824 and VR 826. The system is configured to allow users to generate and distribute music using a MIDI having superior sound outputs.

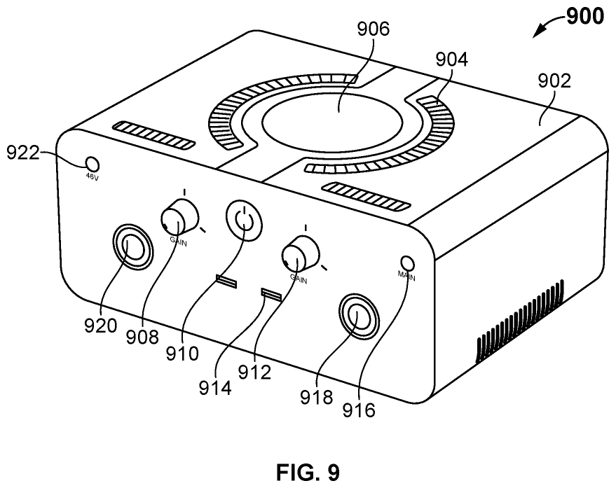

FIG. 9 shows a front perspective view of a MIDI in one embodiment of the present invention. In this embodiment, the MIDI comprises computer module includes a motherboard with built-in WIFI controller, a processor, RAM, an SSD drive, and a video card, audio interface, and on the outside, LED indicators and external power supply. More specifically, the housing 902 comprises LED indicators 904 configured to show volume, a volume toggle 906, left gain toggle 908, Power button 910, right gain toggle 912, headphone jack 916, LED indicators 914, I/Os 918 and 920, and voltage button 922.

The gain toggles 908 and 912 are configured to allow the user to, during gain stage, make adjustments to the level, such as a fader on a mixing console or in a UAW, for example. The LED indicators are configured to show the levels of gain manipulation. The voltage button 922 is configured to 48V. The I/Os are configured to similar to those described in FIGS. 3-6.

### EXAMPLES

In one embodiment, the hard drive is loaded with software and the processor are configured to enable the viewers and listeners to experience the live music performances via the VR platform. The musicians or music creators have a music studio space within the platform where they may create music and collaborate with other musicians using the MIDI.

In one embodiment, a software application is provided with all software functionality loaded thereon. In one embodiment, the personal VR studio room includes exclusive skins for customized experience, studio (posters, couches, TVs, pool tables, refrigerators, etc.), gear (monitors, consoles, amps, consoles, retro gear etc.), instrument skin overlays (guitars, pianos, keyboards, bass guitars, CDJs, etc.), access to CDJ scans of their real CDJs to be played in the platform while being manipulated and controlled in the real world, and experience small studio animations custom to each studio skin (bugs in a garage studio, flickering lights in a basement studio, and rain on the windows in a Paris loft studio).

The application provides different tools for creating music, full recording software package within VR space, ability to record and perform with live instruments based in the real world channeled into the VR world through the interface, and also ability to instantly collaborate within other users studios (if agreed upon by studio owner).

In one embodiment, the users could perform live music, ability to perform full live sets in designated venues or their own studio space by using the interface, and access to major venues, throwback venues, and promotional venues to perform by booking (e.g., underground punk clubs, etc.). In one embodiment, the users have opportunities to earn income by releasing music, instant music release option: platform to host and monetize within VR platform (cost included), and release option: user pays premium for full distribution within the VR space and to major streaming sites (iTunes®, Spotify®, Amazon®, etc.) by the platform.

In one embodiment, users may have opportunities to earn income by music promotion capabilities include music submission to promotions and major name brand promotions within the VR space (i.e., battle of the bands, corporate sponsored open mic nights, opening slots for major artist, etc.), receive “radio airplay” within the platform, playlist submission access to be listened to by fellow users and users on personal studio devices within VR (juke boxes, boom boxes, record players, Walkman, etc.), and verification through the submission process branding them a “top tier” artist. In one embodiment, the users have opportunities to earn income by e-sales include monetize live performances, parties in their studio spaces, tip functions, and sell custom digital goods (i.e., avatar merch, posters, tapes, CD, vinyl, VIP access passes to their studios and shows, etc.), upload loops and melodies to sell in producers store, and unlockable “record store” option (upon reaching a certain level) for fans to browse and buy goods.

In one embodiment, additional incentives for users include, but not limited to, access to all platform functions of users, greater access to events and other creator based functions (access to artist green rooms at VR venues, VIP booths at clubs), skin, and feature downloads before users, awards (platinum plaques, statues, gold instruments, high profile performance slots) based on set parameters by monitoring their music's, social impact and progress within the platform, longer access to open mics and open decks to perform their creations for votes (points) from the audience they can put towards more skins or even DAW software plugins, and ability to win, and or buy famous studio skins and the like.

In one embodiment, the users may download the software application from VR app store. Fans have their own basic studio with basic music making capabilities. They could venture out to visit music venues or music studios where music creator users are making and performing music. They are free to roam and interact with musicians and fans and explore new music created in the platform. In one embodiment, the users may select personal avatar, access basic avatar customizability, and in-app purchase avatar skins etc. In one embodiment, the users may access a personal VR studio room with several basic items for decorating (lamp, beanbag, pizza boxes, laptop, etc.), in-app purchase decorative items for their studio apartment, purchase or earn points to buy more studio space and goods to expand, and host parties in studio space and invite favorite artists to attend (and perform live).

In one embodiment, the users may access tools for creating music include, but not limited to, very basic music editing software (basic DAW) within their studio (allows 1 minute of rearranging free looped samples that can be played on different devices (bought with points), or designated venues, all within the platform and able to perform their limited (platform provided) music creation on open decks or open mics for a limited performance time to receive votes (points) to obtain more goods (users could perform a longer time and use original music they've made within the platform through the platform). The users access to music spaces may include, travel from scene to scene by leaving their studio space through the door, access to venues, coffee shops, and user studios (when user allows), and also have mobile device within the VR space to access friends, events, buy goods, track artists, and do other basic functions.

In one embodiment, users may update experience using/buying points of NFT or Coins to access VIP music events and parties, purchase or earn the ability to open venue and monetize ticket sales, venue related goods (drinks, VIP table access, party hats, etc.) and book artists, gain points through a variety of tasks and goals related to attending shows, venues, supporting artists, and doing things like drinking too much coffee, or dancing nonstop for an hour, use points to purchase tickets and backstage access to major concert and festival events featuring major label artists, get to experience “theme” days with special sketch, color, and retro themes they can add to their studios, and also could pay for purchasing their favorite artist's merchandise from their stores.

In one embodiment, the software application enables advertisers to advertise and promote digital goods include campaign themed items for users to win and/or purchases.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A musical instrument digital interface (MIDI) controller comprising:
a housing having a hollow interior portion;
a first audio jack and a second audio jack positioned on the housing, wherein the first audio jack is configured to accept a first audio signal from an electronic music instrument, and wherein the second audio jack is configured to accept a second audio signal from a microphone;
a conversion module configured to receive the first signal from the first audio jack and the second signal from the second audio jack, wherein the conversion module is configured to transform the first signal into an outgoing digital signal and retain the second signal in a database;
an output module configured to utilize the outgoing digital signal and the retained second signal from the database, and output both signals as a dual signal of audio and digital outputs during a user performance.

2. The MIDI controller of claim 1, further comprising at least one universal serial bus port and network module for enabling communication with a virtual reality (VR) component.

3. The MIDI controller of claim 1, further comprising a power input positioned on the housing, wherein the power input is configured to supply electrical power to the device.

4. The MIDI controller of claim 2, further comprising a short-wave communications module configured to communicate with a digital audio workstation and the VR component.

5. The MIDI controller of claim 1, wherein the electronic music instrument is a guitar.

6. The MIDI controller of claim 1, wherein the electronic music instrument is a keyboard or drum.

7. The MIDI controller of claim 1, further comprising a workflow database, wherein the workflow database is in communication with the output module, and the workflow database is configured to store music for use by the user.

8. A system for performing producing and distributing media, the system comprising:
a musical instrument digital interface (MIDI) controller comprising:
a housing having a hollow interior portion;
a first audio jack and a second audio jack positioned on the housing, wherein the first audio jack is configured to accept a first audio signal from an electronic music instrument, and wherein the second audio jack is configured to accept a second audio signal from a microphone;
a conversion module configured to receive the first signal from the first audio jack and the second signal from the second audio jack, wherein the conversion module is configured to transform the first signal into an outgoing digital signal and retain the second signal in a database;
an output module configured to utilize the outgoing digital signal and the retained second signal from the database, and output both signals as a dual signal of audio and digital outputs;
a digital audio workstation module configured to communicate with the MIDI and generate a media using the dual signal of audio and digital outputs;
a virtual reality (VR) module in communication with the digital audio workstation, wherein the VR module is configured to receive a signal from the digital audio workstation module to allow a user to interact with the media.

9. The system of claim 8, wherein the digital audio module is configured to allow the user to create events, provide content creator incentives, and distribute the media.

10. The system of claim 8, wherein the MIDI comprises at least one universal serial bus port and network module for enabling communication with a VR headset.

11. The system of claim 10, wherein the MIDI comprises a short-wave communications module configured to communicate with a digital audio workstation and the VR headset.

12. The system of claim 8, wherein the electronic music instrument is a guitar.

13. The system of claim 8, wherein the electronic music instrument is a keyboard or drum.

14. The system of claim 8, wherein the MIDI comprises a workflow database, wherein the workflow database is in communication with the output module, and the workflow database is configured to store music for use by the user.

15. A method performed by a processor of mixing a MIDI signals, the method comprising:
accepting a first audio signal from an electronic music instrument using a first audio jack on a MIDI controller;
accepting a second signal from a microphone using a second audio jack on the MIDI controller;
transforming the first signal into an outgoing digital signal;
retaining the second signal in a database;
transforming t the first signal into an outgoing digital signal and retaining the second signal in a database using a conversion module; and
mixing the outgoing digital signal and the saved second signal during a user performance and outputting both signals as a dual signal of audio and digital outputs.

16. The method of claim 15, further comprising outputting the performance to a virtual reality headset.

17. The method of claim 15, further comprising sending, via the processor and short-wave communications module the signals to a digital audio workstation.

18. The method of claim 15, wherein the electronic music instrument is a guitar.

19. The method of claim 15, wherein the electronic music instrument is a keyboard or drum.

20. The method of claim 16, further comprising communicating with a digital audio workstation and the VR headset.
